(19) United States
(12) Patent Application Publication
(10) Pub. No.: US 2008/0059995 A1
(43) Pub. Date: Mar. 6, 2008

(54) SELECTIVE DISPLAY OF OVERLAY VIDEO STREAMS VIA INTERACTIVE ALERT ICONS

(75) Inventors: David Eric Shanks, Los Angeles, CA (US); Richard F. Purpura, Orange, CA (US); Matthew J. Thompson, Torrance, CA (US); David E. Feldstein, Santa Monica, CA (US)

Correspondence Address: THE DIRECTV GROUP, INC.;PATENT DOCKET ADMINISTRATION, CA / LA1 / A109, P O BOX 956, EL SEGUNDO, CA, 90245-0956, US

(73) Assignee: THE DIRECTV GROUP, INC., El Segundo, CA (US)

(21) Appl. No.: 11/843,581

(22) Filed: Aug. 22, 2007

Related U.S. Application Data
(60) Provisional application No. 60/839,624, filed on Aug. 23, 2006.

(51) Int. Cl. H04N 7/10; H04N 7/173

(52) U.S. Cl. 725/32; 725/114

(57) ABSTRACT

An interactive alert system displayed on a video monitor. The system comprises a first video stream presenting at least video information, the first video stream comprising a viewer channel, and an overlay video stream, displayed simultaneously with the first video stream, wherein the overlay video stream provides information on a second video stream.

### CROSS-REFERENCE TO RELATED APPLICATIONS

This application claims the benefit under 35 U.S.C Section 119(e) of U.S. Provisional Application Ser. No. 60/839,624, filed on Aug. 23, 2006, by David E. Shanks et al., entitled “SELECTIVE DISPLAY OF OVERLAY VIDEO STREAMS VIA INTERACTIVE ALERT ICONS,” which application is incorporated by reference herein.

### BACKGROUND OF THE INVENTION

1. Field of the Invention

The present invention relates generally to satellite video systems, and in particular, to a method, apparatus, and article of manufacture for interactive mosaic channel video streams.

2. Description of the Related Art

Satellite broadcasting of communications signals has become commonplace. Satellite distribution of commercial signals for use in television programming currently utilizes multiple feedhorns on a single Outdoor Unit (ODU) which supply signals to up to eight IRDs on separate cables from a multiswitch.

FIG. 1 illustrates a typical satellite television installation of the related art.

System 100 uses signals sent from Satellite A (SatA) 102, Satellite B (SatB) 104, and Satellite C (SatC) 106 that are directly broadcast to an Outdoor Unit (ODU) 108 that is typically attached to the outside of a house 110. ODU 108 receives these signals and sends the received signals to IRD 112, which decodes the signals and separates the signals into viewer channels, which are then passed to monitor 114 for viewing by a user. There can be more than one satellite transmitting from each orbital location.

Satellite uplink signals 116 are transmitted by one or more uplink facilities 118 to the satellites 102-104 that are typically in geosynchronous orbit. Satellites 102-106 amplify and rebroadcast the uplink signals 116, through transponders located on the satellite, as downlink signals 120. Depending on the satellite 102-106 antenna pattern, the downlink signals 120 are directed towards geographic areas for reception by the ODU 108.

Each satellite 102-106 broadcasts downlink signals 120 in typically thirty-two (32) different frequencies, which are licensed to various users for broadcasting of programming, which can be audio, video, or data signals, or any combination. These signals are typically located in the Ku-band of frequencies, i.e., 11-18 GHz. Future satellites will likely broadcast in the Ka-band of frequencies, i.e., 18-40 GHz, but typically 20-30 GHz. Further, signals 120 can be sent to IRD 112 via cable 122 rather than or in addition to the use of satellites 102-106.

As satellites 102-106 broadcast additional services and additional channels to viewers, viewers will like and expect to see programming on monitor 114 that relate to their specific needs and desires.

### SUMMARY OF THE INVENTION

To minimize the limitations in the prior art, and to minimize other limitations that will become apparent upon reading and understanding the present specification, the present invention discloses an alert system displayed on a video monitor, which comprises a first video stream presenting at least video information, the first video stream comprising a viewer channel, and an overlay video stream, displayed simultaneously with the first video stream, wherein the overlay video stream provides information on a second video stream.

Such a system further optionally comprises the overlay video stream providing for interaction with a viewer of the overlay video stream, display of the overlay video stream being controlled by an IRD coupled to a video monitor, the IRD displaying the overlay video stream on a select set of viewer channels, the IRD displaying the overlay video stream based on a time of day, the overlay video stream providing additional information on the second video stream, the additional information comprising at least a type of program shown on the second video stream, the interaction comprising directly tuning to the second video stream, and the interaction comprising removing the overlay video stream from display on the video monitor.

Another system in accordance with the present invention displays a plurality of individual video feeds at a given time, and comprises a broadcast delivery system, comprising a transmitter and a receiver, a monitor, coupled to the receiver, for displaying a first video stream presenting at least video information, the first video stream comprising a viewer channel, and an overlay video stream, displayed simultaneously with the first video stream, wherein the overlay video stream provides information on a second video stream.

Such a system further optionally comprises the broadcast delivery system is a satellite television delivery system, the overlay video stream providing interactive services to a viewer of the overlay video stream, the overlay video stream being separate from the video information, the overlay video stream being selectively viewable on a first viewer channel and a second viewer channel, the overlay video stream being viewed on the first viewer channel and the second viewer channel during a change in viewer channel from the first viewer channel to the second viewer channel, the overlay video stream being selectively viewed on the first viewer channel and the second viewer channel during a change in viewer channel from the first viewer channel to the second viewer channel based on at least a characteristic of the second viewer channel, the selective viewing of the overlay video stream being based on a characteristic of the receiver, and the receiver preventing viewing of the overlay video stream.

Another system for displaying a plurality of individual video feeds at a given time in accordance with the present invention comprises means for transmitting the plurality of individual video feeds, means for displaying a first video stream presenting at least video information, the first video stream comprising a viewer channel, and means for displaying an overlay video stream simultaneously with the first video stream, wherein the overlay video stream provides information on a second video stream.

Such a system further optionally comprises means for controlling the overlay video stream, and the means for controlling the overlay video stream being a receiver located proximate to the means for displaying.

Other features and advantages are inherent in the system disclosed or will become apparent to those skilled in the art from the following detailed description and its accompanying drawings.

### BRIEF DESCRIPTION OF THE DRAWINGS

Referring now to the drawings in which like reference numbers represent corresponding parts throughout:

FIG. 1 illustrates a typical satellite television installation of the related art;

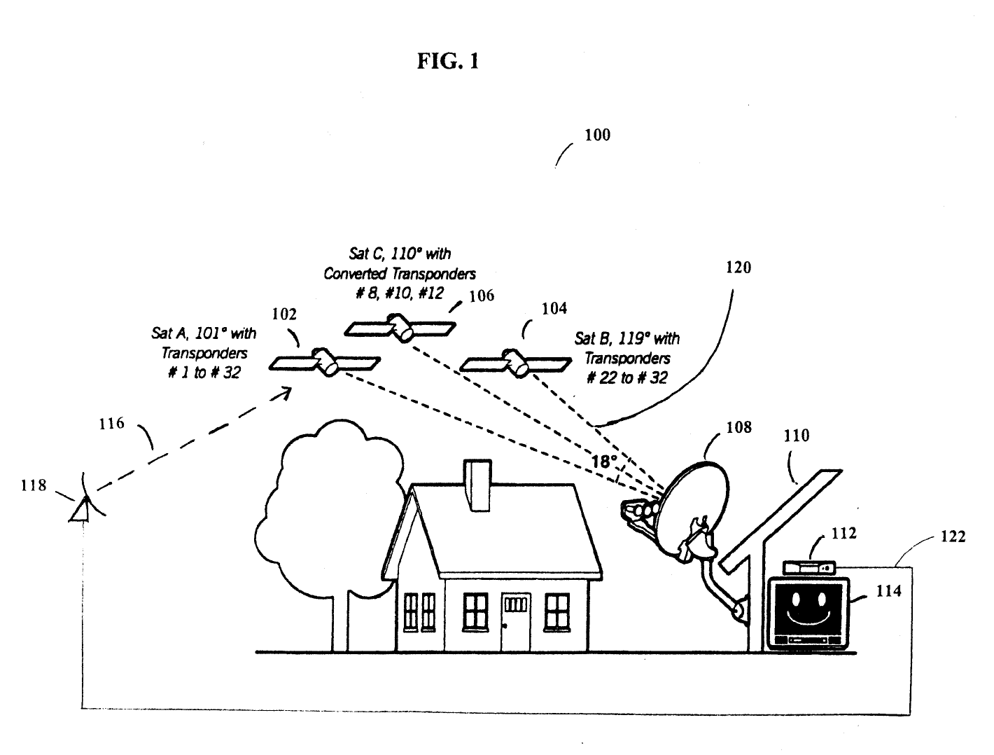

FIG. 2 illustrates the overlay video stream of the present invention; and

FIG. 3 illustrates the additional information available within the overlay video stream of the present invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Overview

The present invention is an interactive television channel that allows a viewer to view a video stream while receiving an overlay video stream used to announce other items of potential interest to the viewer. The video stream with the overlay is typically delivered to a user's monitor 114 via system 100, but could be done using cable or other terrestrial techniques. Further, the overlay allows for interaction between the user and the IRD 112 to obtain more information should there be interest in the overlay video.

When a viewer watches a specific program on a monitor 114, they are watching a “viewer channel” that comprises video and audio information that is routed to a specific “channel” to the monitor 114. For example, when a viewer wants to watch the local FOX affiliate station, they know that station is associated with a specific channel number on their monitor 114 or IRD 112, e.g., channel 11. When they program or otherwise indicate to the monitor 114 or IRD 112 to tune to channel 11, the monitor 114 or IRD 112 manipulates the electronics to capture and present the video information associated with that command from the satellite downlink 120, or from another source such as a coaxial cable input (cable TV) or terrestrial broadcast frequencies to present that information on monitor 114. The “viewer channel” information is typically the information that is presented when a viewer selects a given “channel” on the monitor 114 or IRD 112.

The present invention provides an overlay video stream, sometimes called a “snipe,” which provides the viewer with information of upcoming events, other programs of potential interest to the viewer, etc.

The present invention also allows a viewer to select various levels of information delivery within the overlay video stream via use of the remote control buttons that perform various functions in interacting with the overlay video stream. Such interaction is based on commands sent by the viewer, typically via the remote control, to select defined functions within the overlay video stream. Such a presentation is typically referred to as an “interactive channel,” an “interactive matrix channel,” or an “interactive mosaic channel” herein.

Within the interactive mosaic channel, the viewer is given several choices of commands to use based on the portion of the overlay video stream the viewer is currently watching.

There can be more than one overlay video stream as described above, and, as such each of the overlay channels can have a thematic core, genre, or subject. For example, the overlay video stream can be shown on a given set of viewer channels based on the content of the overlay video stream, or on historical or other metrics known by the IRD. For example, and not by way of limitation, if the overlay video stream comprises information about an upcoming sports event, if the viewer is watching a predominantly sports-oriented channel, e.g., ESPN or FOX SPORTS WEST, then the IRD 112 and/or transmission station 118 can authorize the display of the overlay video stream on those channels. Further, if the channel history of the IRD 112 indicates that the viewer typically watches sports-oriented channels, regardless of which channel the IRD 112 is tuned to at the current time, the IRD 112 can display the overlay video stream because it is likely that the viewer will be interested in the information content of the overlay video stream.

Alert Screen

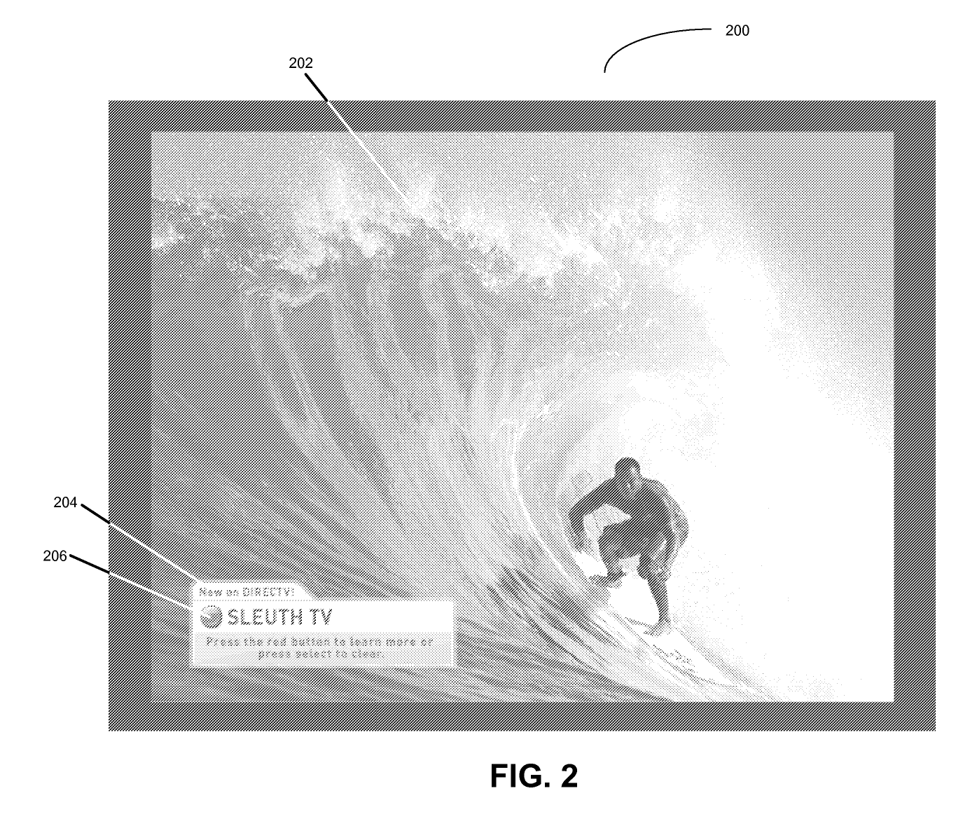

FIG. 2 illustrates the overlay video stream of the present invention.

Screen 200 is typically displayed on monitor 114, with video stream 202 and overlay video stream 204 being present when the overlay video stream 204 is activated by IRD 112. Overlay video stream 204 comprises information about an upcoming event, new channel launch, or other pertinent information, and appears as an alert on the monitor 114 for viewing.

Previous approaches to such snipes are part of the video stream 202, and appear typically just after commercial breaks in video stream 202, and appeared for as long as the snipe was recorded in video stream 202. Further, there are no interactive services associated with previous approaches. The present invention uses a separate video stream, the overlay video stream 204, to provide interactive services and the ability for the viewer to remove the snipe from the screen if desired.

As shown in FIG. 2, overlay video stream 204 has information to inform the viewer that buttons on the remote control will perform specific functions related to the overlay video stream 204. For example, and not by way of limitation, FIG. 2 illustrates that the “red” button will display additional information about the upcoming “Sleuth TV” channel, and that pressing the “Select” button will remove the overlay video stream from display on monitor 114.

The overlay video stream can be programmed to appear at any time based on the transmission station 118's commands to IRD 112, unlike the burned-in previous attempts that only occur at the time the snipe was included in video stream 202. Further, the overlay video stream 204 can be programmed to appear for a specific period of time, e.g., five seconds, ten seconds, fifteen seconds, etc., to allow viewers to read the information contained within overlay video stream 204.

If a viewer chooses to allow the overlay video stream 204 to remain on the screen without performing any of the listed commands, or performs some or all of the commands listed, the overlay video stream 204 can be programmed to be removed from display on the monitor 114, and can also be programmed to reappear on the monitor 114 depending on conditions determined by the IRD 112. For example, if the viewer essentially ignores the overlay video stream 202, and tunes to another viewer channel (different video stream 202), depending on the channel tuned to, the IRD 112 may or may not display the overlay video stream 204, based on rules determined by the IRD 112, the transmission station 118, or other factors. Further, if the viewer pressed the button to remove the overlay video stream 204, when the IRD 112 is tuned to a new video stream 202, the IRD 112 will likely not repeat the same overlay video stream 204. However, if the IRD is left on a channel for a lengthy period of time, or turned off and then powered on again, the IRD may repeat the display of overlay video stream 204 when the power-on condition is recognized by the IRD 112.

Further, time of day may play into whether or not overlay video stream 204 is displayed on monitor 114. For example, and not by way of limitation, if the IRD 112 knows that it is 3:00 am local time, and the IRD 112 has not changed viewer channel for the past five hours, it is more likely than not that the monitor 114 is turned off and nobody is watching the monitor 114. As such, the IRD 112 may choose not to display the overlay video stream 204 at this time, and wait for a more likely time to have a viewer watching monitor 114, e.g., prime time television hours.

IRD 112 can keep track of how many times a given overlay video stream 204 has been displayed on monitor 114, and adjust whether or not to redisplay the overlay video stream 204 again, or the transmission station and IRD 112 can have a fixed number of displays for the overlay video stream 204 regardless of time of day or other factors. IRD 112 can also be programmed to not display overlay video stream 204, if the command to view additional data within overlay video stream 204 has been viewed.

Further, transmission station 118 and IRD 112 have the ability to prevent overlay video stream 204 from appearing on certain channels, e.g., children's programming channels, because of the content of overlay video stream, or, if desired, the viewer can provide commands to IRD 112 to avoid the display of overlay video stream 204 on any channel available to IRD 112.

Further Information Screen

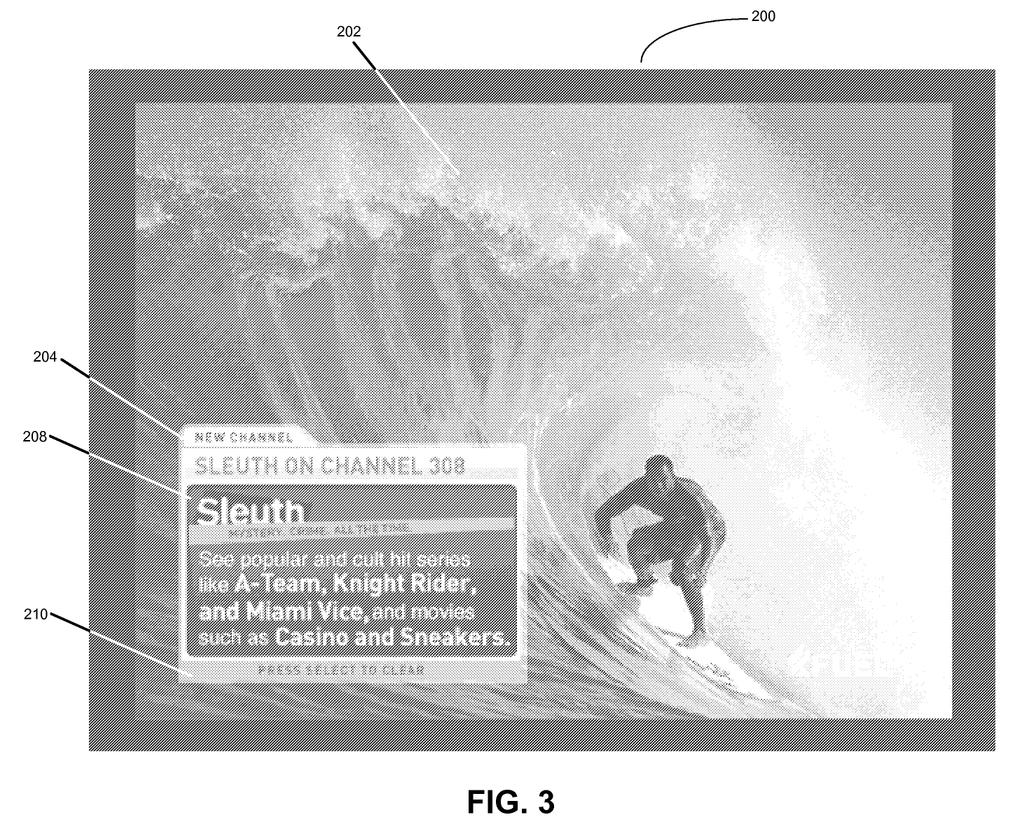

FIG. 3 illustrates the additional information available within the overlay video stream of the present invention.

Again, screen 200 is typically displayed on monitor 114, with video stream 202 and overlay video stream 204 being present when the overlay video stream 204 is activated by IRD 112. However, once the designated button is activated, video stream 204 displays additional information in screen 208, and also may provide additional commands in command section 210. For example, and not by way of limitation, the additional information screen 208 may include the type of event, the types of programs being shown on the advertised channel in overlay video stream 204, or the genre of the channel, as well as times and dates for viewing or other appropriate and pertinent times and dates. Further, command section 210 can provide a direct tuning button command, which may be another button on the remote control, which will allow the viewer to directly tune to the channel mentioned in overlay video stream 204. Such a command may be accessible via any display of overlay video stream 204, whether it is the display shown in FIG. 2, FIG. 3, or any other configuration is considered within the scope of the present invention.

The additional information screen 208 can also be programmed to appear on the monitor for a specified amount of time, e.g., five seconds, ten seconds, etc., depending on the amount of information presented in screen 208, and can also be paused via command by the viewer if desired so that the viewer can peruse the information at their leisure. Commands can also be provided to remove the overlay video screen 204 from display on monitor 114 if desired.

### CONCLUSION

The present invention discloses an alert system displayed on a video monitor, which comprises a first video stream presenting at least video information, the first video stream comprising a viewer channel, and an overlay video stream, displayed simultaneously with the first video stream, wherein the overlay video stream provides information on a second video stream.

Such a system further optionally comprises the overlay video stream providing for interaction with a viewer of the overlay video stream, display of the overlay video stream being controlled by an IRD coupled to a video monitor, the IRD displaying the overlay video stream on a select set of viewer channels, the IRD displaying the overlay video stream based on a time of day, the overlay video stream providing additional information on the second video stream, the additional information comprising at least a type of program shown on the second video stream, the interaction comprising directly tuning to the second video stream, and the interaction comprising removing the overlay video stream from display on the video monitor.

Another system in accordance with the present invention displays a plurality of individual video feeds at a given time, and comprises a broadcast delivery system, comprising a transmitter and a receiver, a monitor, coupled to the receiver, for displaying a first video stream presenting at least video information, the first video stream comprising a viewer channel, and an overlay video stream, displayed simultaneously with the first video stream, wherein the overlay video stream provides information on a second video stream.

Such a system further optionally comprises the broadcast delivery system is a satellite television delivery system, the overlay video stream providing interactive services to a viewer of the overlay video stream, the overlay video stream being separate from the video information, the overlay video stream being selectively viewable on a first viewer channel and a second viewer channel, the overlay video stream being viewed on the first viewer channel and the second viewer channel during a change in viewer channel from the first viewer channel to the second viewer channel, the overlay video stream being selectively viewed on the first viewer channel and the second viewer channel during a change in viewer channel from the first viewer channel to the second viewer channel based on at least a characteristic of the second viewer channel, the selective viewing of the overlay video stream being based on a characteristic of the receiver, and the receiver preventing viewing of the overlay video stream.

Another system for displaying a plurality of individual video feeds at a given time in accordance with the present invention comprises means for transmitting the plurality of individual video feeds, means for displaying a first video stream presenting at least video information, the first video stream comprising a viewer channel, and means for displaying an overlay video stream simultaneously with the first video stream, wherein the overlay video stream provides information on a second video stream.

Such a system further optionally comprises means for controlling the overlay video stream, and the means for controlling the overlay video stream being a receiver located proximate to the means for displaying.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description.

What is claimed is:

1. An alert system displayed on a video monitor, comprising
a first video stream presenting at least video information, the first video stream comprising a viewer channel; and
an overlay video stream, displayed simultaneously with the first video stream, wherein the overlay video stream provides information on a second video stream.

2. The alert system of claim 1, wherein the overlay video stream provides for interaction with a viewer of the overlay video stream.

3. The alert system of claim 2, wherein display of the overlay video stream is controlled by an IRD coupled to a video monitor.

4. The alert system of claim 3, wherein the IRD displays the overlay video stream on a select set of viewer channels.

5. The alert system of claim 3, wherein the IRD displays the overlay video stream based on a time of day.

6. The alert system of claim 2, wherein the overlay video stream provides additional information on the second video stream, the additional information comprising at least a type of program shown on the second video stream.

7. The alert system of claim 2, wherein the interaction comprises directly tuning to the second video stream.

8. The alert system of claim 2, wherein the interaction comprises removing the overlay video stream from display on the video monitor.

9. A system for displaying a plurality of individual video feeds at a given time, comprising:
a broadcast delivery system, comprising a transmitter and a receiver;
a monitor, coupled to the receiver, for displaying a first video stream presenting at least video information, the first video stream comprising a viewer channel; and
an overlay video stream, displayed simultaneously with the first video stream, wherein the overlay video stream provides information on a second video stream.

10. The system of claim 9, wherein the broadcast delivery system is a satellite television delivery system.

11. The system of claim 10, wherein the overlay video stream provides interactive services to a viewer of the overlay video stream.

12. The system of claim 11, wherein the overlay video stream is separate from the video information.

13. The system of claim 12, wherein the overlay video stream is selectively viewable on a first viewer channel and a second viewer channel.

14. The system of claim 13, wherein the overlay video stream is viewed on the first viewer channel and the second viewer channel during a change in viewer channel from the first viewer channel to the second viewer channel.

15. The system of claim 14, wherein the overlay video stream is selectively viewed on the first viewer channel and the second viewer channel during a change in viewer channel from the first viewer channel to the second viewer channel based on at least a characteristic of the second viewer channel.

16. The system of claim 13, wherein the selective viewing of the overlay video stream is based on a characteristic of the receiver.

17. The system of claim 16, wherein the receiver prevents viewing of the overlay video stream.

18. A system for displaying a plurality of individual video feeds at a given time, comprising:
means for transmitting the plurality of individual video feeds;
means for displaying a first video stream presenting at least video information, the first video stream comprising a viewer channel; and
means for displaying an overlay video stream simultaneously with the first video stream, wherein the overlay video stream provides information on a second video stream.

19. The system of claim 18, further comprising means for controlling the overlay video stream.

20. The system of claim 18, wherein the means for controlling the overlay video stream is a receiver located proximate to the means for displaying.
